(19) United States
(12) Patent Application Publication
(10) Pub. No.: US 2007/0071013 A1
(43) Pub. Date: Mar. 29, 2007

(54) Method and system for increasing capacity of DVB-H downlink communication channel

(76) Inventor: Pieter van Rooyen, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 11/237,227

(22) Filed: Sep. 28, 2005

(51) Int. Cl. H04L 12/56

(52) U.S. Cl. 370/395.64

(57) ABSTRACT

Certain aspects of a method and system for processing signals in a communication system may include receiving a plurality of spatially multiplexed communication signals for a plurality of channels via a digital video broadcast (DVB) communication path. A plurality of channel weights may be applied to at least a portion of the plurality of spatially multiplexed communication signals. High definition television (HDTV) broadcast information may be received via the DVB communication path. A phase and an amplitude of at least a portion of the received plurality of spatially multiplexed communication signals may be adjusted based on the applied plurality of channel weights. The applied plurality of channel weights may comprise at least one of: amplitude correction weights and phase correction weights. The received plurality of spatially multiplexed communication signals may be spatially demultiplexed.

### CROSS-REFERENCE TO RELATED APPLICATIONS/INCORPORATION BY REFERENCE

This application makes reference to:
U.S. application Ser. No. 11/172,759 (Attorney Docket No. 16208US02) filed Jun. 30, 2005; and
U.S. application Ser. No. 11/010,461 (Attorney Docket No. 16332US01) filed Dec. 13, 2004.

Each of the above stated applications is hereby incorporated by reference in its entirety.

### FIELD OF THE INVENTION

Certain embodiments of the invention relate to communication channels. More specifically, certain embodiments of the invention relate to a method and system for increasing capacity of a DVB-H downlink communication channel.

### BACKGROUND OF THE INVENTION

Broadcasting and telecommunications have historically occupied separate fields. In the past, broadcasting was largely an “over-the-air” medium while wired media carried telecommunications. That distinction may no longer apply as both broadcasting and telecommunications may be delivered over either wired or wireless media. Present development may adapt broadcasting to mobility services. One limitation has been that broadcasting may often require high bit rate data transmission at rates higher than could be supported by existing mobile communications networks. However, with emerging developments in wireless communications technology, even this obstacle may be overcome.

Terrestrial television and radio broadcast networks have made use of high power transmitters covering broad service areas, which enable one-way distribution of content to user equipment such as televisions and radios. By contrast, wireless telecommunications networks have made use of low power transmitters, which have covered relatively small areas known as “cells”. Unlike broadcast networks, wireless networks may be adapted to provide two-way interactive services between users of user equipment such as telephones and computer equipment.

The introduction of cellular communications systems in the late 1970's and early 1980's represented a significant advance in mobile communications. The networks of this period may be commonly known as first generation, or “1G” systems. These systems were based upon analog, circuit-switching technology, the most prominent of these systems may have been the advanced mobile phone system (AMPS). Second generation, or “2G” systems ushered improvements in performance over 1G systems and introduced digital technology to mobile communications. Exemplary 2G systems include the global system for mobile communications (GSM), digital AMPS (D-AMPS), and code division multiple access (CDMA). Many of these systems have been designed according to the paradigm of the traditional telephony architecture, often focused on circuit-switched services, voice traffic, and supported data transfer rates up to 14.4 kbits/s. Higher data rates were achieved through the deployment of “2.5G” networks, many of which were adapted to existing 2G network infrastructures. The 2.5G networks began the introduction of packet-switching technology in wireless networks. However, it is the evolution of third generation, or “3G” technology that may introduce fully packet-switched networks, which support high-speed data communications.

The general packet radio service (GPRS), which is an example of a 2.5G network service oriented for data communications, comprises enhancements to GSM that required additional hardware and software elements in existing GSM network infrastructures. Where GSM may allot a single time slot in a time division multiple access (TDMA) frame, GPRS may allot up to 8 such time slots providing a data transfer rate of up to 115.2 kbits/s. Another 2.5G network, enhanced data rates for GSM evolution (EDGE), also comprises enhancements to GSM, and like GPRS, EDGE may allocate up to 8 time slots in a TDMA frame for packet-switched, or packet mode, transfers. However, unlike GPRS, EDGE adapts 8 phase shift keying (8-PSK) modulation to achieve data transfer rates that may be as high as 384 kbits/s.

The universal mobile telecommunications system (UMTS) is an adaptation of a 3G system, which is designed to offer integrated voice, multimedia, and Internet access services to portable user equipment. The UMTS adapts wideband CDMA (W-CDMA) to support data transfer rates, which may be as high as 2 Mbits/s. One reason why W-CDMA may support higher data rates is that W-CDMA channels may have a bandwidth of 5 MHz versus the 200 kHz channel bandwidth in GSM. A related 3G technology, high speed downlink packet access (HSDPA), is an Internet protocol (IP) based service oriented for data communications, which adapts W-CDMA to support data transfer rates of the order of 10 Mbits/s. HSDPA achieves higher data rates through a plurality of methods. For example, many transmission decisions may be made at the base station level, which is much closer to the user equipment as opposed to being made at a mobile switching center or office. These may include decisions about the scheduling of data to be transmitted, when data are to be retransmitted, and assessments about the quality of the transmission channel. HSDPA may also utilize variable coding rates in transmitted data. HSDPA also supports 16-level quadrature amplitude modulation (16-QAM) over a high-speed downlink shared channel (HS-DSCH), which permits a plurality of users to share an air interface channel.

The multiple broadcast/multicast service (MBMS) is an IP datacast service, which may be deployed in EDGE and UMTS networks. The impact of MBMS is largely within the network in which a network element adapted to MBMS, the broadcast multicast service center (BM-SC), interacts with other network elements within a GSM or UMTS system to manage the distribution of content among cells within a network. User equipment may be required to support functions for the activation and deactivation of MBMS bearer service. MBMS may be adapted for delivery of video and audio information over wireless networks to user equipment. MBMS may be integrated with other services offered over the wireless network to realize multimedia services, such as multicasting, which may require two-way interaction with user equipment.

Standards for digital television terrestrial broadcasting (DTTB) have evolved around the world with different systems being adopted in different regions. The three leading DTTB systems are, the advanced standards technical committee (ATSC) system, the digital video broadcast terrestrial (DVB-T) system, and the integrated service digital broadcasting terrestrial (ISDB-T) system. The ATSC system has largely been adopted in North America, South America, Taiwan, and South Korea. This system adapts trellis coding and 8-level vestigial sideband (8-VSB) modulation. The DVB-T system has largely been adopted in Europe, the Middle East, Australia, as well as parts of Africa and parts of Asia. The DVB-T system adapts coded orthogonal frequency division multiplexing (COFDM). The ISDB-T system has been adopted in Japan and adapts bandwidth segmented transmission orthogonal frequency division multiplexing (BST-OFDM). The various DTTB systems may differ in important aspects; some systems employ a 6 MHz channel separation, while others may employ 7 MHz or 8 MHz channel separations. Planning for the allocation of frequency spectrum may also vary among countries with some countries integrating frequency allocation for DTTB services into the existing allocation plan for legacy analog broadcasting systems. In such instances, broadcast towers for DTTB may be co-located with broadcast towers for analog broadcasting services with both services being allocated similar geographic broadcast coverage areas. In other countries, frequency allocation planning may involve the deployment of single frequency networks (SFNs), in which a plurality of towers, possibly with overlapping geographic broadcast coverage areas (also known as “gap fillers”), may simultaneously broadcast identical digital signals. SFNs may provide very efficient use of broadcast spectrum as a single frequency may be used to broadcast over a large coverage area in contrast to some of the conventional systems, which may be used for analog broadcasting, in which gap fillers transmit at different frequencies to avoid interference.

Even among countries adopting a common DTTB system, variations may exist in parameters adapted in a specific national implementation. For example, DVB-T not only supports a plurality of modulation schemes, comprising quadrature phase shift keying (QPSK), 16-QAM, and 64 level QAM (64-QAM), but DVB-T offers a plurality of choices for the number of modulation carriers to be used in the COFDM scheme. The “2K” mode permits 1,705 carrier frequencies that may carry symbols, each with a useful duration of 224 μs for an 8 MHz channel. In the “8K” mode there are 6,817 carrier frequencies, each with a useful symbol duration of 896 μs for an 8 MHz channel. In SFN implementations, the 2K mode may provide comparatively higher data rates but smaller geographical coverage areas than may be the case with the 8K mode. Different countries adopting the same system may also employ different channel separation schemes.

While 3G systems are evolving to provide integrated voice, multimedia, and data services to mobile user equipment, there may be compelling reasons for adapting DTTB systems for this purpose. One of the more notable reasons may be the high data rates that may be supported in DTTB systems. For example, DVB-T may support data rates of 15 Mbits/s in an 8 MHz channel in a wide area SFN. There are also significant challenges in deploying broadcast services to mobile user equipment. Many handheld portable devices, for example, may require that services consume minimum power to extend battery life to a level, which may be acceptable to users. Another consideration is the Doppler effect in moving user equipment, which may cause inter-symbol interference in received signals. Among the three major DTTB systems, ISDB-T was originally designed to support broadcast services to mobile user equipment. While DVB-T may not have been originally designed to support mobility broadcast services, a number of adaptations have been made to provide support for mobile broadcast capability. The adaptation of DVB-T to mobile broadcasting is commonly known as DVB handheld (DVB-H).

To meet requirements for mobile broadcasting the DVB-H specification may support time slicing to reduce power consumption at the user equipment, addition of a 4K mode to enable network operators to make tradeoffs between the advantages of the 2K mode and those of the 8K mode, and an additional level of forward error correction on multi-protocol encapsulated data-forward error correction (MPE-FEC) to make DVB-H transmissions more robust to the challenges presented by mobile reception of signals and to potential limitations in antenna designs for handheld user equipment. DVB-H may also use the DVB-T modulation schemes, like QPSK and 16-quadrature amplitude modulation (16-QAM), which may be more resilient to transmission errors. MPEG audio and video services may be more resilient to error than data, thus additional forward error correction may not be required to meet DTTB service objectives.

Time slicing may reduce power consumption in user equipment by increasing the burstiness of data transmission. Instead of transmitting data at the received rate, under time slicing techniques, the transmitter may delay the sending of data to user equipment and send data later but at a higher bit rate. This may reduce total data transmission time over the air, time, which may be used to temporarily power down the receiver at the user equipment. Time slicing may also facilitate service handovers as user equipment moves from one cell to another because the delay time imposed by time slicing may be used to monitor transmitters in neighboring cells. The MPE-FEC may comprise Reed-Solomon coding of IP data packets, or packets using other data protocols. The 4K mode in DVB-H may utilize 3,409 carriers, each with a useful duration of 448 μs for an 8 MHz channel. The 4K mode may enable network operators to realize greater flexibility in network design at minimum additional cost. Importantly, DVB-T and DVB-H may coexist in the same geographical area. Transmission parameter signaling (TPS) bits that are carried in the header of transmitted messages may indicate whether a given DVB transmission is DVB-T or DVB-H, in addition to indicating whether DVB-H specific features, such as time slicing, or MPE-FEC are to be performed at the receiver. As time slicing may be a mandatory feature of DVB-H, an indication of time slicing in the TPS may indicate that the received information is from a DVB-H service.

In most current wireless communication systems, nodes in a network may be configured to operate based on a single transmit and a single receive antenna. However, for many current wireless systems, the use of multiple transmit and/or receive antennas may result in an improved overall system performance. These multi-antenna configurations, also known as smart antenna techniques, may be utilized to reduce the negative effects of multipath and/or signal interference may have on signal reception. Existing systems and/or systems which are being currently deployed, for example, CDMA-based systems, TDMA-based systems, WLAN systems, and OFDM-based systems such as IEEE 802.11 a/g/n, may benefit from configurations based on multiple transmit and/or receive antennas. It is anticipated that smart antenna techniques may be increasingly utilized both in connection with the deployment of base station infrastructure and mobile subscriber units in cellular systems to address the increasing capacity demands being placed on those systems. These demands arise, in part, from a shift underway from current voice-based services to next-generation wireless multimedia services that provide voice, video, and data communication.

The utilization of multiple transmit and/or receive antennas is designed to introduce a diversity gain and array gain and to suppress interference generated within the signal reception process. Such diversity gains improve system performance by increasing received signal-to-noise ratio, by providing more robustness against signal interference, and/or by permitting greater frequency reuse for higher capacity. In communication systems that incorporate multi-antenna receivers, a set of M receive antennas may be utilized to null the effect of (M-1) interferers. Accordingly, N signals may be simultaneously transmitted in the same bandwidth using N transmit antennas, with the transmitted signal then being separated into N respective signals by way of a set of N antennas deployed at the receiver. Systems that utilize multiple transmit and multiple receive antenna may be referred to as multiple-input multiple-output (MIMO) systems. One attractive aspect of multi-antenna systems, in particular MIMO systems, is the significant increase in system capacity that may be achieved by utilizing these transmission configurations. For a fixed overall transmitted power, the capacity offered by a MIMO configuration may scale with the increased signal-to-noise ratio (SNR).

However, the widespread deployment of multi-antenna systems in wireless communications, particularly in wireless handset devices, has been limited by the increased cost that results from increased size, complexity, and power consumption. The necessity of providing a separate RF chain for each transmit and receive antenna is a direct factor in the increased cost of multi-antenna systems. Each RF chain generally comprises a low noise amplifier (LNA), a filter, a downconverter, and an analog-to- digital converter (A/D). In certain existing single-antenna wireless receivers, the single required RF chain may account for over 30% of the receiver's total cost. It is therefore apparent that as the number of transmit and receive antennas increases, the system complexity, power consumption, and overall cost may increase.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for increasing capacity of a DVB-H downlink communication channel, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary system for providing integrated services between a cellular network and a digital video broadcast network, in accordance with an embodiment of the invention.

FIG. 1B is a block diagram of an exemplary system for providing integrated services including high definition television (HDTV) between a cellular network and a digital video broadcast network, in accordance with an embodiment of the invention.

FIG. 1C is a high-level block diagram of exemplary DVB-H receiver circuitry in a mobile terminal, which may be utilized in connection with an embodiment of the invention.

FIG. 1D is a block diagram illustrating the sharing of a multiplexer (MUX) by a plurality of MPEG2 services, which may be utilized in connection with an embodiment of the invention.

FIG. 2A is a block diagram of a mobile terminal that is adapted to receive DVB-H broadcasts and cellular communications, in accordance with an embodiment of the invention.

FIG. 2B is a block diagram illustrating a receive processing circuit of an RF integrated circuit (RFIC), in accordance with an embodiment of the invention.

FIG. 3A is a block diagram of an exemplary system for providing phase rotation, channel estimation and for determining optimal phase and amplitude parameters or settings for an additional receive antenna, in accordance with an embodiment of the invention.

FIG. 3B is a block diagram of an exemplary system for providing phase rotation, channel estimation and for determining optimal phase and amplitude parameters or setting for additional K-1 receive antennas, in accordance with an embodiment of the invention.

FIG. 3C is a block diagram of an exemplary receiver system, in accordance with an embodiment of the invention.

FIG. 4A is a block diagram of exemplary N Tx antenna and M Rx antenna spatially multiplexed wireless communication system with multiple RF chains and receiver channel estimation, in accordance with an embodiment of the invention.

FIG. 4B is a flow diagram illustrating exemplary steps for determining channel weight utilizing SINR or SNR in an additional receive antenna, in accordance with an embodiment of the invention.

FIG. 5 is a block diagram of an exemplary receiver illustrating spatial multiplexing in a MIMO communication system that may be utilized in connection with an embodiment of the invention.

### DETAILED DESCRIPTION OF THE INVENTION

Certain aspects of a method and system for processing signals in a communication system may comprise receiving a plurality of spatially multiplexed communication signals for a plurality of channels via a digital video broadcast (DVB) communication path. A plurality of channel weights may be applied to at least a portion of the plurality of spatially multiplexed communication signals. High definition television (HDTV) broadcast information may be received via the DVB communication path. A phase and an amplitude of at least a portion of the received plurality of spatially multiplexed communication signals may be adjusted based on the applied plurality of channel weights. The applied plurality of channel weights may comprise at least one of: amplitude correction weights and phase correction weights. The received plurality of spatially multiplexed communication signals may be spatially demultiplexed. The plurality of spatially multiplexed communication signals for the plurality of channels may be received via a digital video broadcast handheld (DVB-H) communication path. The plurality of spatially multiplexed communication signals may be combined to generate a single combined receive signal. A plurality of channel estimates may be determined based on the combined plurality of spatially multiplexed communication signals.

Spatial multiplexing (SM) may provide a mode of signal transmission predicated upon the use of multiple antennas at both a transmitter and a receiver, for example, in such a way that the capacity of a wireless radio link may be increased without correspondingly increasing power or bandwidth consumption. In a case in which N antennas are used at both a transmitter and a receiver, an input stream of information symbols provided to the transmitter is divided into N independent substreams. Spatial multiplexing contemplates that each of these N independent substreams may occupy the same “space-time channel”, for example, time slot, frequency, or code/key sequence, of the applicable multiple-access protocol. Within the transmitter, each substream may be separately applied to the N transmit antennas and propagated over an intervening multipath communication channel to a receiver. Error correction coding may be applied to each of the N streams separately or in a combined space-time methodology.

The composite multipath signals may then be received by an array of N or more receive antennas deployed at the receiver. At the receiver, a “spatial signature” defined by the N phases and N amplitudes arising at the receive antenna array for a given substream may be then estimated. Signal processing techniques may be then applied in order to spatially separate the received signals, which may allow the original substreams to be recovered and synthesized into the original input symbol stream. An overall system capacity of the order of the minimum of M and N, min(M,N), for example, may be achieved, where M may be the number of receive antennas and N may be the number of transmit antennas for flat fading channel conditions. The principles of spatially multiplexed communication and exemplary system implementations are further described in, for example, “Optimum combining for indoor radio systems with multiple users”, by J. H. Winters, IEEE Transactions on Communications, Vol. COM-35, No. 11, November 1987, which is hereby incorporated by reference in its entirety.

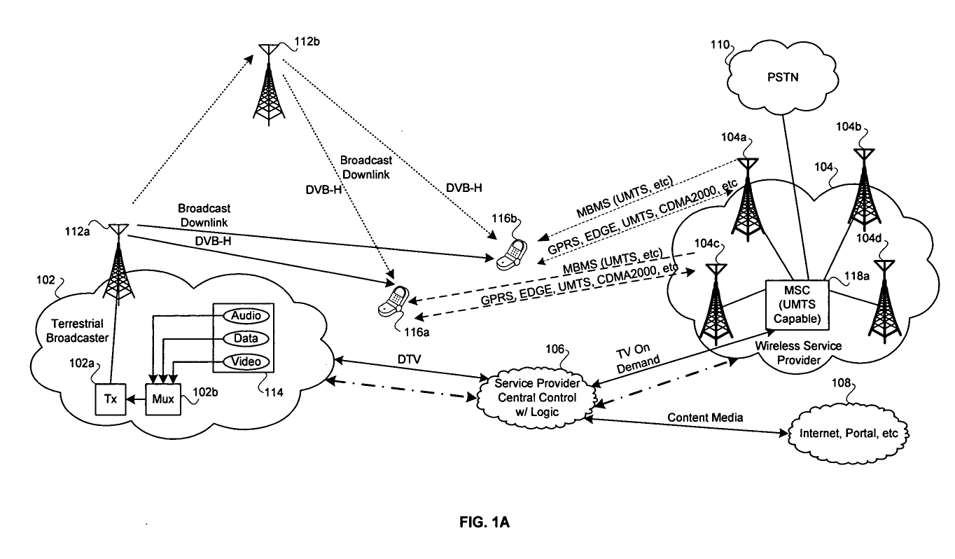

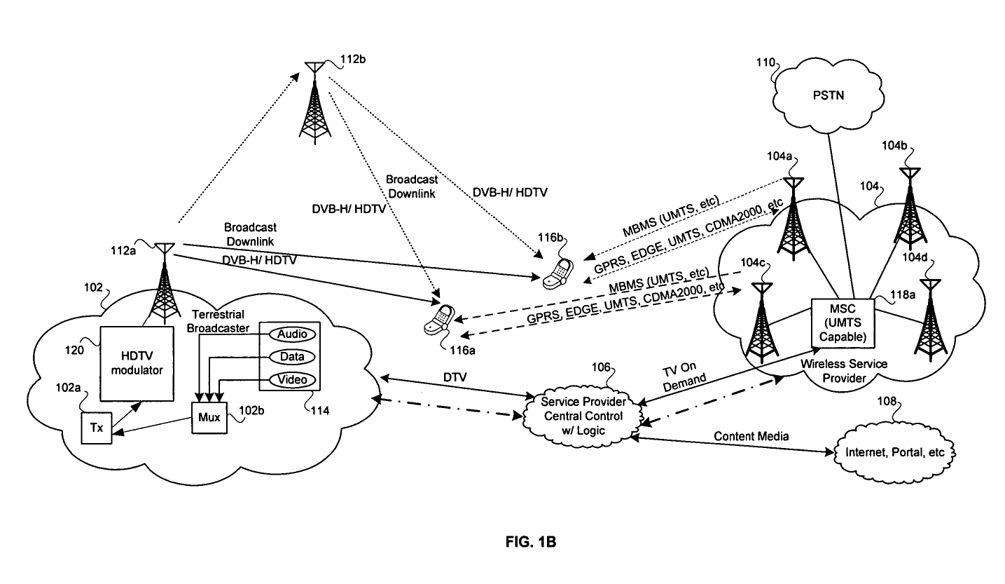

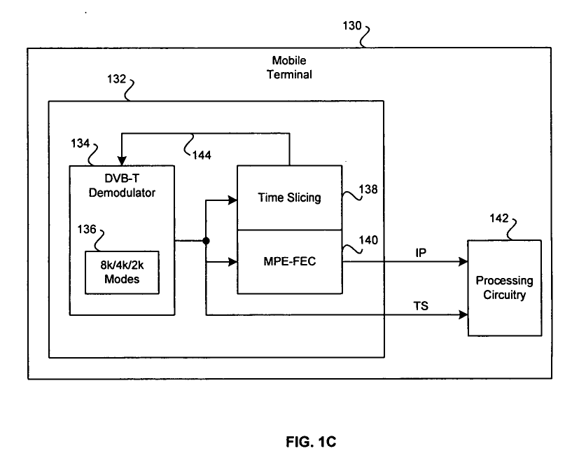

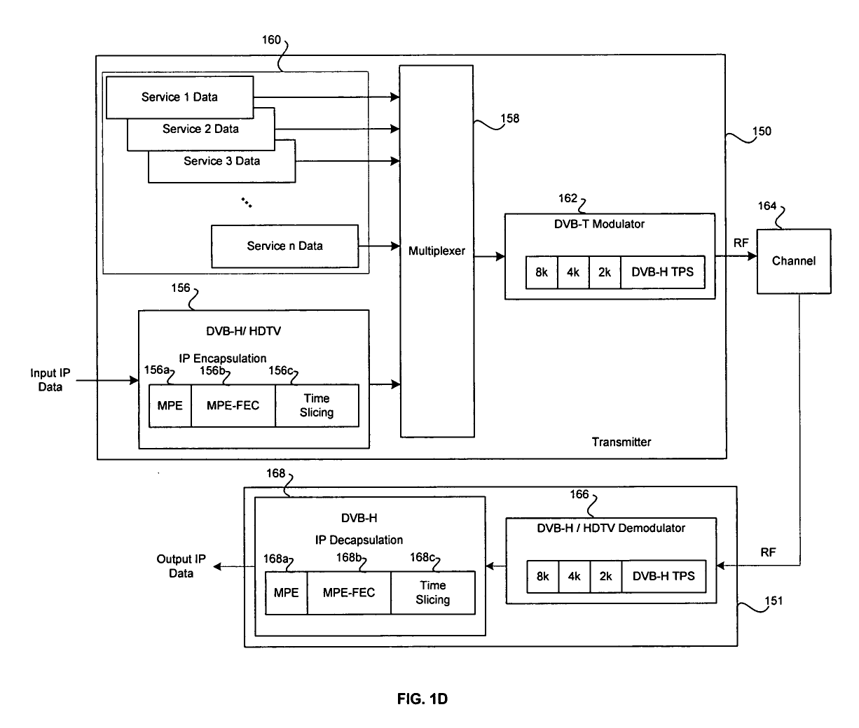

FIG. 1A is a block diagram of an exemplary system for providing integrated services between a cellular network and a digital video broadcast network, in accordance with an embodiment of the invention. Referring to FIG. 1A, there is shown terrestrial broadcaster network 102, wireless service provider network 104, service provider 106, portal 108, public switched telephone network (PSTN) 110, and mobile terminals (MTs) 116a and 116b. The terrestrial broadcaster network 102 may comprise transmitter (Tx) 102a, multiplexer (Mux) 102b, and information content source 114. The content source 114 may also be referred to as a data carousel, which may comprise audio, data and video content. The terrestrial broadcaster network 102 may also comprise DVB-H broadcast antennas 112a and 112b. The wireless service provider network 104 may comprise mobile switching center (MSC) 118a, and a plurality of cellular base stations 104a, 104b, 104c, and 104d.

The terrestrial broadcaster network 102 may comprise suitable equipment that may be adapted to encode and/or encrypt data for transmission via the transmitter 102a. The transmitter 102a in the terrestrial broadcaster network 102 may be adapted to utilize DVB-H broadcast channels to communicate information to the mobile terminals 116a, 116b. The multiplexer 102b associated with the terrestrial broadcaster network 102 may be utilized to multiplex data from a plurality of sources. For example, the multiplexer 102b may be adapted to multiplex various types of information such as audio, video and/or data into a single pipe for transmission by the transmitter 102a. Content media from the portal 108, which may be handled by the service provider 106 may also be multiplexed by the multiplexer 102b. The portal 108 may be an ISP service provider.

In one aspect of the invention, the terrestrial broadcaster network 102 may be adapted to provide one or more digital television (DTV) channels to the service provider 106. In this regard, the terrestrial broadcaster network 102 may comprise suitable high-speed or broadband interfaces that may be utilized to facilitate transfer of the DTV channels from the terrestrial broadcast network 102 to the service provider. The service provider 106 may then utilize at least a portion of the DTV channels to provide television (TV) on demand service, or other similar types of services to the wireless service provider network 104. Accordingly, the service provider 106 may further comprise suitable high-speed or broadband interfaces that may be utilized to facilitate the transfer of related TV on demand information to the MSC 118a.

Although communication links between the terrestrial broadcast network 102 and the service provider 106, and also the communication links between the service provider 106 and the wireless service provider 104 may be wired communication links, the invention may be not so limited. Accordingly, at least one of these communication links may be wireless communication links. In an exemplary embodiment of the invention, at least one of these communication links may be an 802.x based communication link such an 802.16 or WiMax broadband access communication link. In another exemplary embodiment of the invention, at least one of these connections may be a broadband line of sight (LOS) connection.

The wireless service provider network 104 may be a cellular or personal communication service (PCS) provider that may be adapted to handle broadcast UMTS (B-UMTS). The term cellular as utilized herein refers to both cellular and PCS frequencies bands. Hence, usage of the term cellular may comprise any band of frequencies that may be utilized for cellular communication and/or any band of frequencies that may be utilized for PCS communication. Notwithstanding, broadcast UMTS (B-UMTS) may also be referred to as MBMS. MBMS is a high-speed data service that is overlaid on WCDMA to provide much higher data rates than may be provided by core WCDMA. In this regard, the B-UMTS services may be superimposed on the cellular or PCS network.

The wireless service provider network 104 may utilize cellular or PCS access technologies such as GSM, CDMA, CDMA2000, WCDMA, AMPS, N-AMPS, and/or TDMA. The cellular network may be utilized to offer bi-directional services via uplink and downlink communication channels, while the B-UMTS or MBMS network may be utilized to provide a unidirectional broadband services via a downlink channel. The B-UMTS or MBMS unidirectional downlink channel may be utilized to broadcast content media and/or multimedia type information to the mobile terminals 116a and 116b. Although MBMS provides only unidirectional downlink communication, the invention may be not so limited. In this regard, other bidirectional communication methodologies comprising uplink and downlink capabilities, whether symmetric or asymmetric, may be utilized.

Although the wireless service provider network 104 is illustrated as a GSM, CDMA, WCDMA based network and/or variants thereof, the invention is not limited in this regard. Accordingly, the wireless service provider network 104 may be an 802.11 based wireless network or wireless local area network (WLAN). The wireless service provider network 104 may also be adapted to provide 802.11 based wireless communication in addition to GSM, CDMA, WCDMA, CDMA2000 based network and/or variants thereof. In this case, the mobile terminals 116a, 116b may also be compliant with the 802.11 based wireless network.

In accordance with an exemplary embodiment of the invention, if the mobile terminal (MT) 116a is within an operating range of the DVB-H broadcasting antenna 112a and moves out of the latter's operating range and into an operating range of the DVB-H broadcasting antenna 112b, then DVB-H broadcasting antenna 112b may be adapted to provide DVB-H broadcast services to the mobile terminal 116a. If the mobile terminal 116a subsequently moves back into the operating range of the DVB-H broadcasting antenna 112a, then the broadcasting antenna 112a may be adapted to provide DVB-H broadcasting service to the mobile terminal 116a. In a somewhat similar manner, if the mobile terminal (MT) 116b is within an operating range of the DVB-H broadcasting antenna 112b and moves out of the latter's operating range and into an operating range of the broadcasting antenna 112a, then the DVB-H broadcasting antenna 112a may be adapted to provide DVB-H broadcasting service to the mobile terminal 116b. If the mobile terminal 116b subsequently moves back into the operating range of broadcasting antenna 112b, then the DVB-H broadcasting antenna 112b may be adapted to provide DVB-H broadcast services to the mobile terminal 116b.

The service provider 106 may comprise suitable interfaces, circuitry, logic and/or code that may be adapted to facilitate communication between the terrestrial broadcasting network 102 and the wireless communication network 104. In an illustrative embodiment of the invention the service provider 106 may be adapted to utilize its interfaces to facilitate exchange control information with the terrestrial broadcast network 102 and to exchange control information with the wireless service provider 104. The control information exchanged by the service provider 106 with the terrestrial broadcasting network 102 and the wireless communication network 104 may be utilized to control certain operations of the mobile terminals, the terrestrial broadcast network 102 and the wireless communication network 104.

In accordance with an embodiment of the invention, the service provider 106 may also comprise suitable interfaces, circuitry, logic and/or code that may be adapted to handle network policy decisions. For example, the service provider 106 may be adapted to manage a load on the terrestrial broadcast network 104 and/or a load on the wireless service provider network 104. Load management may be utilized to distribute the flow of information throughout the terrestrial broadcast network 104 and/or a load on the wireless service provider network 104. For example, if information is to be broadcasted via the wireless service provider network 104 to a plurality of mobile terminals within a particular cell handled by the base station 104a and it is determined that this may overload the wireless service provider network 104, then the terrestrial broadcast network 102 may be configured to broadcast the information to the mobile terminals.

The service provider 106 may also be adapted to handle certain types of service requests, which may have originated from a mobile terminal. For example, the mobile terminal 116a may request that information be delivered to it via a downlink DVB-H broadcast channel. However, a downlink DVB-H broadcast channel may be unavailable for the delivery of the requested information. As a result, the service provider 106 may route the requested information through an MBMS channel via the base station 104c to the mobile terminal 116a. The requested information may be acquired from the content source 114 and/or the portal 108. In another example, the mobile terminal 116b may request that information be delivered to it via a downlink cellular channel. However, the service provider 106 may determine that delivery of the information is not critical and/or the cheapest way to deliver to the mobile terminal 116b is via a downlink DVB-H broadcast channel. As a result, the service provider 106 may route the requested information from the portal 108 or content service 114 to the mobile terminal 116b. The service provider 106 may also have the capability to send at least a portion of information to be delivered to, for example, mobile terminal 116a via the DVB-H broadcast channel and a remaining portion of the information to be delivered via the cellular broadcast channel.

The portal 108 may comprise suitable logic, circuitry and/or code that may be adapted to provide content media to the service provider 106 via one or more communication links. These communication links, although not shown, may comprise wired and/or wireless communication links. The content media that may be provided by the portal 108 may comprise audio, data, video or any combination thereof. In this regard, the portal 108 may be adapted to provide one or more specialized information services to the service provider 106.

The public switched telephone network (PSTN) 110 may be coupled to the MSC 118a. Accordingly, the MSC 118a may be adapted to switch calls originating from within the PSTN 110 to one or more mobile terminals serviced by the wireless service provider 104. Similarly, the MSC 118a may be adapted to switch calls originating from mobile terminals serviced by the wireless service provider 104 to one or more telephones serviced by the PSTN 110.

The information content source 114 may comprise a data carousel. In this regard, the information content source 114 may be adapted to provide various information services, which may comprise online data including audio, video and data content. The information content source 114 may also comprise file download, and software download capabilities. In instances where a mobile terminal fails to acquire requested information from the information content source 114 or the requested information is unavailable, then the mobile terminal may acquire the requested information via, for example, a B-UMTS from the portal 108. The request may be initiated through an uplink cellular communication path.

The mobile terminals (MTs) 116a and 116b may comprise suitable logic, circuitry and/or code that may be adapted to handle the processing of uplink and downlink cellular channels for various access technologies and broadcast DVB-H technologies. In an exemplary embodiment of the invention, the mobile terminals 116a, 116b may be adapted to utilize one or more cellular access technologies such as GSM, GPRS, EDGE, CDMA, WCDMA, CDMA2000, HSDPA and MBMS (B-UMTS). The mobile terminal may also be adapted to receive and process DVB-H broadcast signals in the DVB-H bands. For example, a mobile terminal may be adapted to receive and process DVB-H signals. A mobile terminal may be adapted to request information via a first cellular service and in response, receive corresponding information via a DVB-H broadcast service. A mobile terminal may also be adapted to request information from a service provider via a cellular service and in response, receive corresponding information via a data service, which is provided via the cellular service. The mobile terminals may also be adapted to receive DVB-H broadcast information from either the base stations 104a, 104b, 104c, 104d or the DVB-H broadcast antennas 112a and 112b. In instances where a mobile terminal receives broadcast information from any of the base stations 104a, 104b, 104c, or 104d via a downlink MBMS communication channel, then the mobile terminal may communicate corresponding uplink information via an uplink cellular communication channel.

In one embodiment of the invention, a mobile terminal may be adapted to utilize a plurality of broadcast integrated circuits for receiving and processing DVB-H channels, and a plurality of cellular integrated circuits for receiving and processing cellular or PCS channels. For broadcast channels, each of the plurality of broadcast integrated circuits may be adapted to handle at least one DVB-H channel.

In another embodiment of the invention, a mobile terminal may be adapted to utilize a single broadcast integrated circuit for receiving and processing DVB-H channels, and a single cellular integrated circuit for receiving and processing cellular or PCS channels. For broadcast channels, the single broadcast integrated circuit may be adapted to handle at least one DVB-H channel. Each of the mobile terminals may comprise a single memory interface that may be adapted to handle processing of the broadcast communication information and processing of cellular communication information.

In another embodiment of the invention, a mobile terminal may be adapted to utilize a single integrated circuit for receiving and processing broadcast DVB-H channels, and for receiving and processing cellular or PCS channels. In this regard, the single broadcast and cellular integrated circuit may be adapted to handle different cellular access technologies. For example, the single integrated circuit may comprise a plurality of modules each of which may be adapted to receive and process a particular cellular access technology or a DVB-H broadcast channel.

FIG. 1B is a block diagram of an exemplary system for providing integrated services including high definition television (HDTV) between a cellular network and a digital video broadcast network, in accordance with an embodiment of the invention. Referring to FIG. 1B, there is shown terrestrial broadcaster network 102, wireless service provider network 104, service provider 106, portal 108, public switched telephone network 110, and mobile terminals (MTs) 116a and 116b. The terrestrial broadcaster network 102 may comprise transmitter (Tx) 102a, multiplexer (Mux) 102b, a HDTV modulator 120 and DVB-H broadcast antennas 112a and 112b. Although DVB-H broadcast antenna 112b is illustrated separately from the terrestrial broadcast network 102, it may still be part of the terrestrial broadcast network 102. The wireless service provider network 104 may comprise mobile switching center (MSC) 118a, and a plurality of cellular base stations 104a, 104b, 104c, and 104d.

The system of FIG. 1B is somewhat similar to FIG. 1A with the exception that FIG. 1B has the HDTV modulator 120 that may be adapted to modulate HDTV broadcast information and transmit the modulated HDTV broadcast information to the plurality of DVB-H broadcast antennas 112a and 112b.

In accordance with an embodiment of the invention, spatial multiplexing of multiple-input multiple-output (MIMO) communication signals may be utilized to address spectrum shortaqe for mobile DVB-H. HDTV may require 18 Mbps of bandwidth, for example, for the downlink communication channel. Based on the DVB-T standard, with equivalent channel coding scheme as Advanced Television Systems Committee (ATSC) 8—vestigial sideband (VSB) system with R=2/3 punctured convolutional code, the 6 MHz DVB-T system data throughput may be between 14.7 Mbps and 17.90 Mbps, for example, depending on the guard interval selection. The DVB-T system may not be able to provide HDTV service within a 6 MHz channel, unless a weaker error correction coding is selected. For example, by increasing the convolutional coding rate to R=3/4 and selecting guard insert (GI)=1/16, the data rate increases to 19.6 Mbps, for example, which is comparable with the ATSC system data rate of 19.4 Mbps. However, this approach may require at least 1.5 dB additional signal power, for example. Increasing the coding rate may compromise the performance against the multipath distortions, especially for indoor reception and single frequency network (SFN) environments.

FIG. 1C is a high-level block diagram of exemplary DVB-H receiver circuitry in a mobile terminal, which may be utilized in connection with an embodiment of the invention. Referring to FIG. 1C, there is shown a mobile terminal 130. The mobile terminal 130 may comprise a DVB-H demodulator 132 and processing circuitry block 142. The DVB-H demodulator block 132 may comprise a DVB-T demodulator 134, time slicing block 138, and multi-protocol encapsulated data-forward error correction (MPE-FEC) block 140.

The DVB-T demodulator 134 may comprise suitable circuitry, logic and/or code that may be adapted to demodulate a terrestrial DVB signal. In this regard, the DVB-T demodulator 134 may be adapted to downconvert a received DVB-T signal to a suitable bit rate that may be handled by the mobile terminal 130. The DVB-T demodulator may be adapted to handle 2k, 4k and/or 8k modes.

The time slicing block 138 may comprise suitable circuitry, logic and/or code that may be adapted to minimize power consumption in the mobile terminal 130, particularly in the DVB-T demodulator 134. In general, time slicing reduces average power consumption in the mobile terminal by sending data in bursts via much higher instantaneous bit rates. In order to inform the DVB-T demodulator 134 when a next burst is going to be sent, a delta indicating the start of the next burst is transmitted within a current burst. During transmission, no data for an elementary stream (ES) is transmitted so as to allow other elementary streams to optimally share the bandwidth. Since the DVB-T demodulator 134 knows when the next burst will be received, the DVB-T demodulator 134 may enter a power saving mode between bursts in order to consume less power. Reference 144 indicates a control mechanism that handles the DVB-T demodulator 134 power via the time slicing block 138. The DVB-T demodulator 134 may also be adapted to utilize time slicing to monitor different transport streams from different channels. For example, the DVB-T demodulator 134 may utilize time slicing to monitor neighboring channels between bursts to optimize handover.

The MPE-FEC block 140 may comprise suitable circuitry, logic and/or code that may be adapted to provide error correction during decoding. On the encoding side, MPE-FEC encoding provides improved carrier to noise ratio (C/N), improved Doppler performance, and improved tolerance to interference resulting from impulse noise. During decoding, the MPE-FEC block 140 may be adapted to determine parity information from previously MPE-FEC encoded datagrams. As a result, during decoding, the MPE-FEC block 140 may generate datagrams that are error-free even in instances when received channel conditions are poor. The processing circuitry block 142 may comprise suitable processor, circuitry, logic and/or code that may be adapted to process IP datagrams generated from an output of the MPE-FEC block 140. The processing circuitry block 142 may also be adapted to process transport stream packets from the DVB-T demodulator 134.

In operation, the DVB-T demodulator 134 may be adapted to receive an input DVB-T RF signal, demodulate the received input DVB-T RF signal so as to generate data at a much lower bit rate. In this regard, the DVB-T demodulator 134 recovers MPEG-2 transport stream (TS) packets from the input DVB-T RF signal. The MPE-FEC block 140 may then correct any error that may be located in the data and the resulting IP datagrams may be sent to the processing circuitry block 142 for processing. Transport stream packets from the DVB-T demodulator 134 may also be communicated to the processing circuitry block 142 for processing.

FIG. 1D is a block diagram illustrating the sharing of a multiplexer (MUX) by a plurality of MPEG2 services, which may be utilized in connection with an embodiment of the invention. Referring to FIG. 1D, there is shown a transmitter block 150, a receiver block 151 and a channel 164. The transmitter block 150 may comprise a DVB-H/HDTV encapsulator block 156, a multiplexer 158, and a DVB-T modulator 162. Also shown associated with the transmitter block 150 is a plurality of service data collectively referenced as 160. The receiver block 151 may comprise a DVB-H/HDTV demodulator block 166 and a DVB-H decapsulation block 168. The DVB-H/HDTV encapsulator block 156 may comprise MPE block 156a, MPE-FEC block 156b and time slicing block 156c.

The multiplexer 158 may comprise suitable logic circuitry and/or code that may be adapted to handle multiplexing of IP encapsulated DVB-H/HDTV data and service data. The plurality of service data collectively referenced as 160 may comprise MPEG-2 formatted data, which may comprise for example, audio, video and/or data. The DVB-T modulator 162 may comprise suitable logic circuitry and/or code that may be adapted to generate an output RF signal from the transmitter block 150.

The DVB-H/HDTV demodulator block 166 associated with the receiver block 151 is similar to the DVB-H demodulator block 132 of FIG. 1C. The DVB-H/HDTV demodulator 166 (FIG. 1D) may be adapted to demodulate the received HDTV broadcast information. The DVB-H decapsulation block 168 may comprise MPE block 168a, MPE-FEC block 168b and time slicing block 168c. The DVB-H decapsulation block 168 may comprise suitable logic, circuitry and/or code that may be adapted to decapsulate the IP data that was encapsulated and multiplexed by the transmitter block 150. The output of the DVB-H/HDTV demodulator 166 is the transport stream packets, which comprised the multiplexed output generated by the multiplexer 158.

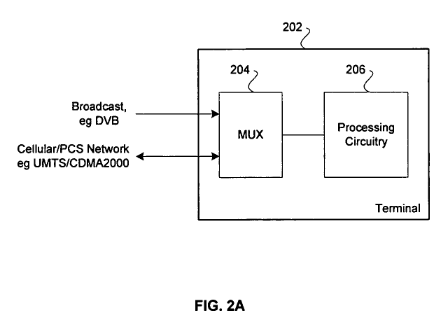

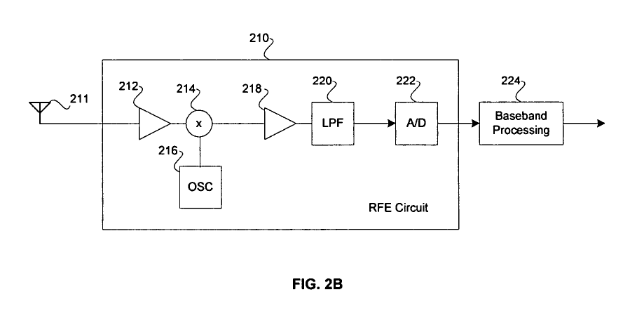

FIG. 2A is a block diagram of a mobile terminal that is adapted to receive DVB-H broadcasts and cellular communications, in accordance with an embodiment of the invention. Referring to FIG. 2A, there is shown a mobile terminal (MT) or handset 202. The mobile terminal 202 may comprise multiplexer (MUX) 204 and processing circuitry 206. The multiplexer 204 may comprise suitable logic circuitry and/or code that may be adapted to multiplex incoming signals, which may comprise DVB-H broadcast channel and at least one cellular channel. The cellular channel may be within the range of both cellular and PCS frequency bands.

The processing circuitry 206 may comprise, for example, an RF integrated circuit (RFIC) or RF front end (RFFE). In this regard, the processing circuitry 206 may comprise at least one receiver front end (RFE) circuit. A first of these circuits may be adapted to handle processing of the DVB-H broadcast channel and a second of these circuits may be adapted to handle a cellular channel. In an embodiment of the invention, a single RFIC may comprise a plurality of RFE processing circuits, each of which may be adapted to process a particular cellular channel. Accordingly, a single RFIC comprising a plurality of cellular RFE processing circuits may be adapted to handle a plurality of cellular channels. In one embodiment of the invention, a plurality of DVB-H RFE processing circuits may be integrated in a single RFIC. In this regard, a mobile terminal may be adapted to simultaneously handle a plurality of different DVB-H channels. For example, a mobile terminal may be adapted to simultaneously receive a first DVB-H channel bearing video and a second DVB-H channel bearing audio.

FIG. 2B is a block diagram illustrating a receive processing circuit of an RF integrated circuit (RFIC), in accordance with an embodiment of the invention. Referring to FIG. 2B, there is shown antenna 211, receiver front end (RFE) circuit 210, and baseband processing block 224. The receiver front end (RFE) circuit 210 may comprise a low noise amplifier (LNA) 212, a mixer 214, an oscillator 216, a low noise amplifier 218, a low pass filter 220 and an analog-to-digital converter (A/D) 222.

The antenna 211 may be adapted to receive at least one of a plurality of signals. For example, the antenna 211 may be adapted to receive a plurality of signals in the GSM band, a plurality of signals in the WCDMA and and/or a plurality of signals in the DVB-H band.

The receiver front end (RFE) circuit 210 may comprise suitable circuitry, logic and/or code that may be adapted to convert a received RF signal down to baseband. An input of the low noise amplifier 212 may be coupled to the antenna 211 so that it may receive RF signals from the antenna 211. The low noise amplifier 212 may comprise suitable logic, circuitry, and/or code that may be adapted to receive an input RF signal from the antenna 211 and amplify the received RF signal in such a manner that an output signal generated by the low noise amplifier 212 has very little additional noise.

The mixer 214 in the RFE circuit 210 may comprise suitable circuitry and/or logic that may be adapted to mix an output of the low noise amplifier 212 with an oscillator signal generated by the oscillator 216. The oscillator 216 may comprise suitable circuitry and/or logic that may be adapted to provide a oscillating signal that may be adapted to mix the output signal generated from the output of the low noise amplifier 212 down to a baseband. The low noise amplifier (LNA) or amplifier 218 may comprise suitable circuitry and/or logic that may be adapted to low noise amplify and output signal generated by the mixer 214. An output of the low noise amplifier or amplifier 218 may be communicated to the low pass filter 220. The low pass filter 220 may comprise suitable logic, circuitry and/or code that may be adapted to low pass filter the output signal generated from the output of the low noise amplifier 220. The low pass filter block 220 retains a desired signal and filters out unwanted signal components such as higher signal components comprising noise. An output of the low pass filter 220 may be communicated to the analog-to-digital converter 222 for processing.

The analog-to-digital converter (A/D) 222 may comprise suitable logic, circuitry and/or code that may be adapted to convert the analog signal generated from the output of the low pass filter 220 to a digital signal. The analog-to-digital converter 222 may generate a sampled digital representation of the low pass filtered signal that may be communicated to the baseband-processing block 224 for processing. The baseband processing block 224 may comprise suitable logic, circuitry and/or code that may be adapted to process digital baseband signals received form an output of the A/D 222. Although the A/D 222 is illustrated as part of the RFE circuit 210, the invention may not be so limited. Accordingly, the A/D 222 may be integrated as part of the baseband processing block 224. In operation, the RFE circuit 210 is adapted to receive RF signals via antenna 211 and convert the received RF signals to a sampled digital representation, which may be communicated to the baseband processing block 224 for processing.

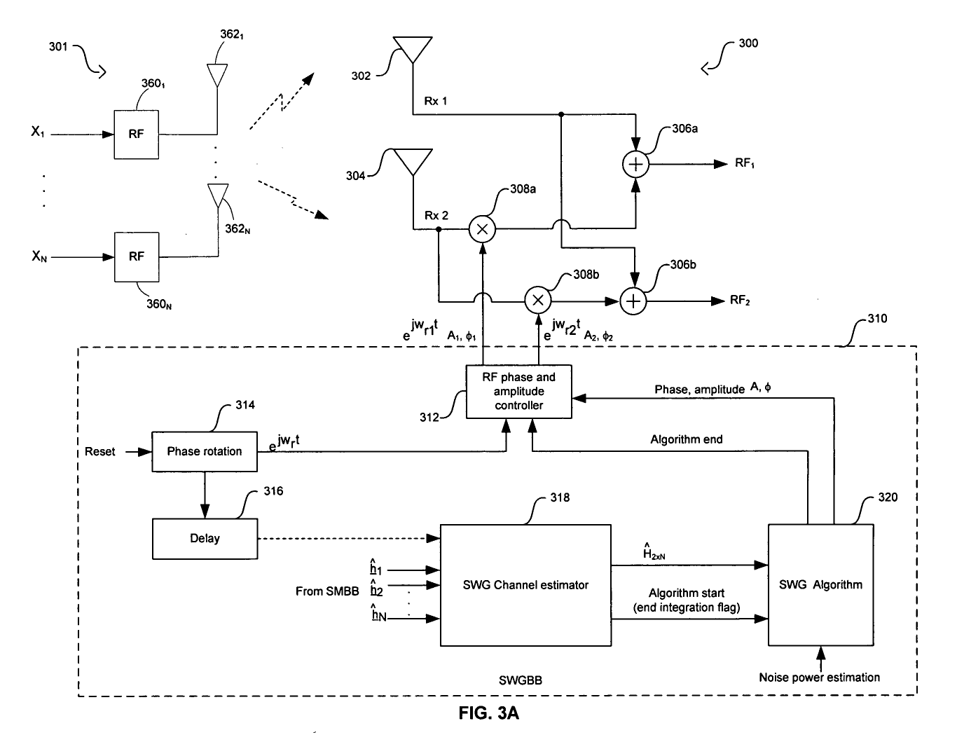

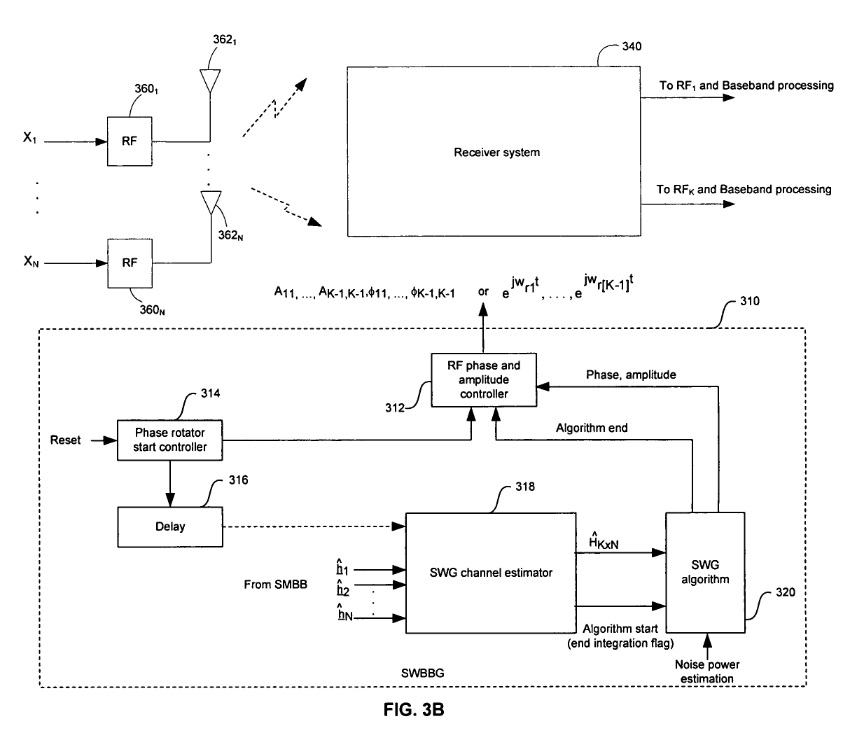

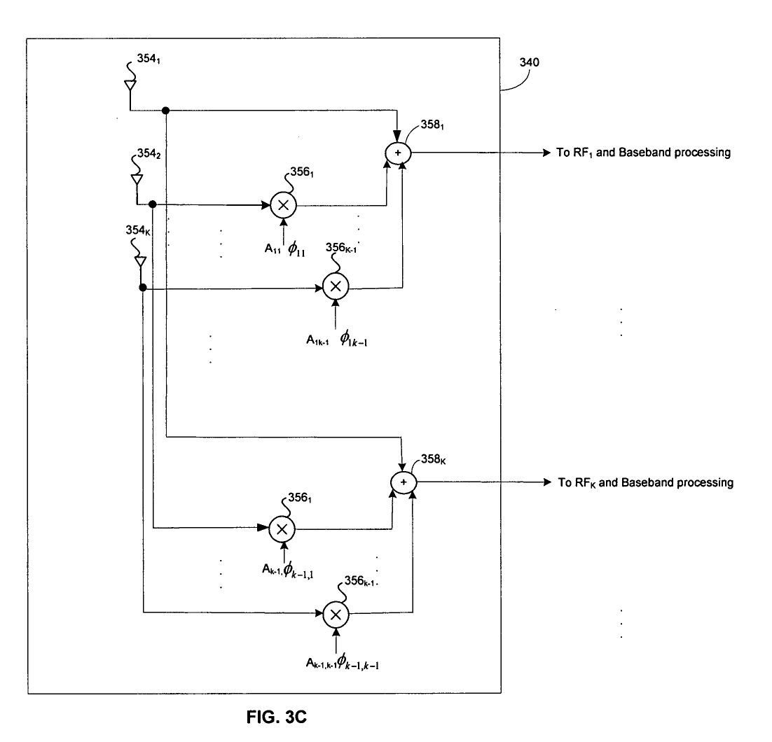

FIG. 3A is a block diagram of an exemplary system for providing phase rotation, channel estimation and for determining optimal phase and amplitude parameters or settings for an additional receive antenna, in accordance with an embodiment of the invention. Referring to FIG. 3A, there is shown a transmitter 301 and a receiver system 300. The transmitter 301 may comprise RF blocks 360_{1 . . . N} and N transmit antennas 3621_{. . . N}. The receiver system 300 may comprise a first receive antenna Rx 1 302, an additional antenna Rx 2 304, combiners 306a and 306b, complex multipliers 308a and 308b, and a single weight generator baseband (SWGBB) processor 310. The SWGBB processor 310 may comprise a phase rotation start controller block 314, a delay block 316, a SWG channel estimator 318, a single weight generator (SWG) algorithm block 320, and a RF phase and amplitude controller 312.

The receive antennas Rx 1 302 and Rx 2 304 may each receive a portion of the transmitted signal. The combiners 306a and 306b may be adapted to combine the received signals into an RF signal RF₁ and an RF signal RF₂, for example. The complex multipliers 308a and 308b may be adapted to receive a plurality of input signals from the additional receive antenna Rx 2 304 and the RF phase and amplitude controller 312 and to generate signals to the complex multipliers 308a and 308b.

The phase rotation start controller block 314 may comprise suitable logic, circuitry and/or that may be adapted to start after receiving a reset signal and may generate a plurality of output signals to the delay block 316 and the RF phase and amplitude controller 312. The delay block 316 may be adapted to receive an input signal from the phase rotation start controller block 314 and generate a delayed output signal to the SWG channel estimator 318. The SWG channel estimator 318 may comprise suitable logic, circuitry, and/or code that may be adapted to process the received baseband combined channel estimates per transmit antenna ĥ₁ . . . ĥ_{N} from the SMBB processor 126 and may generate a matrix Ĥ_{2xN} of processed estimated channels. The SWG channel estimator 318 may be adapted to generate an algorithm start signal indicating the end of integration that may be utilized by the single weight generator (SWG) algorithm block 320.

The SWG algorithm block 320 may be adapted to receive a plurality of signals from the SWG channel estimator 318, for example, a matrix Ĥ_{2xN} of processed baseband combined channel estimates, an algorithm start signal from the SWG channel estimator 318 and a noise power estimation signal. The SWG algorithm block 320 may generate phase and amplitude correction signals and an algorithm end signal to the RF phase and amplitude controller 312. The RF phase and amplitude controller 312 may be adapted to receive the phase and amplitude values and the algorithm end signal from the SWG algorithm block 320 and generate signals that modify the phase and amplitude of a portion of the transmitted signals received by the receive antenna Rx 2 302.

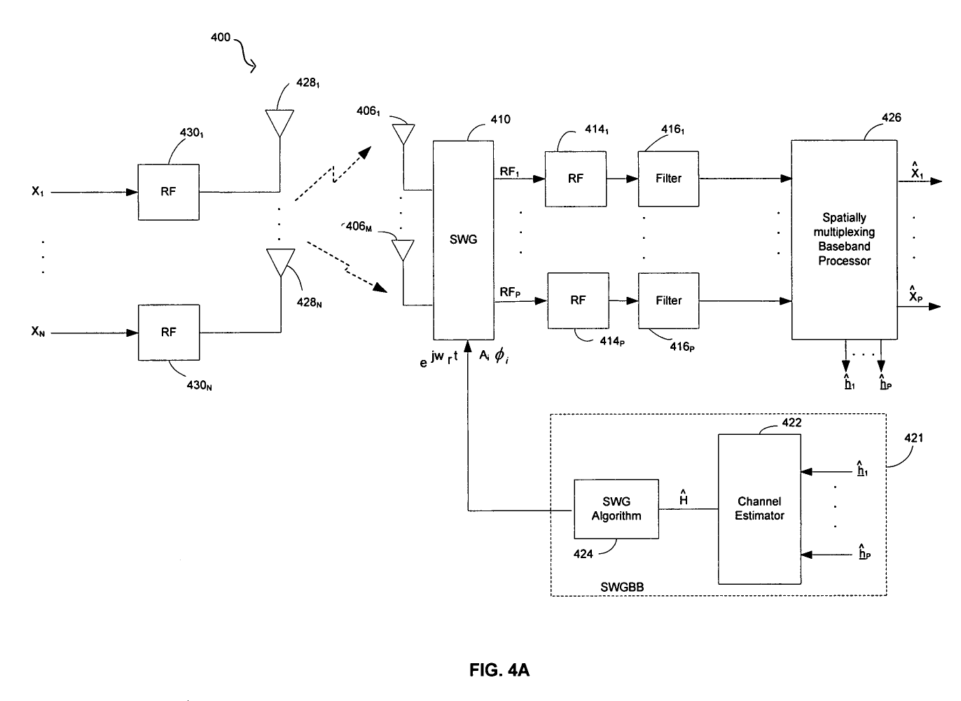

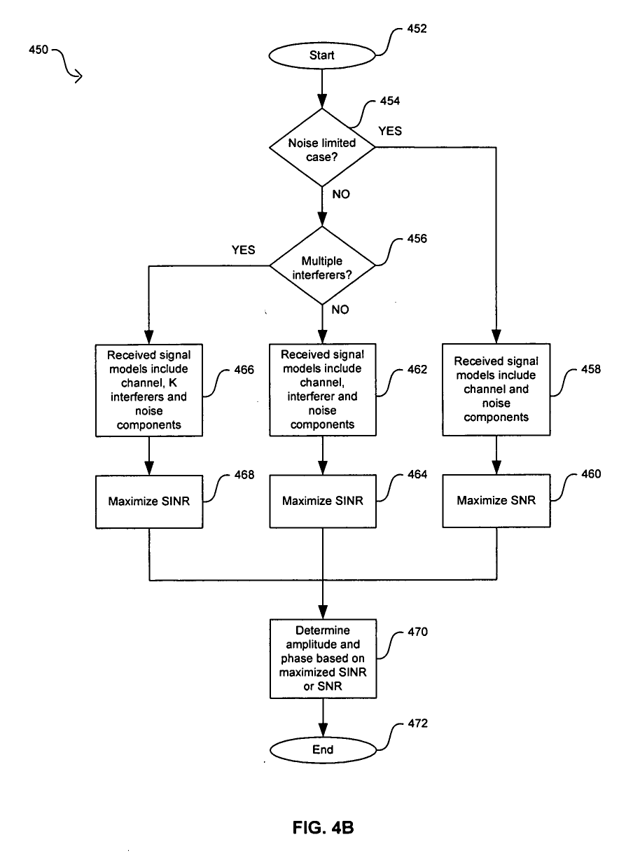

The SWG channel estimator 318 may receive baseband combined channel estimates ĥ₁ . . . ĥ_{N}, which may include all transmission channels from N Tx antennas and each Tx antenna may have a different channel estimation sequence, so that the different combined channels ĥ₁ . . . ĥ_{N} may be separated and estimated. The SWG channel estimator 318 may generate a matrix of channel estimates Ĥ_{2xN} to the SWG algorithm block 320. A reset signal may be utilized to start the phase rotation block 314. The combined channel estimates from the SMBB 426 in FIG. 4 may be transferred to the channel estimator 318 for processing. When processing is complete, the SWG channel estimator 318 may indicate to the SWG algorithm block 320 that the determination of the appropriate phase and amplitude correction for the portion of the received signal in the additional antenna Rx 2 304 may start. The SWG algorithm block 320 may utilize an estimation of the noise power and interference in determining the phase and amplitude values in addition to the matrix of channel estimates Ĥ_{2xN}. The SWG algorithm block 320 may indicate to the RF phase and amplitude controller 312 the end of the weight determination operation and may then transfer to the RF phase and amplitude controller 312, the determined phase and amplitude values. The RF phase and amplitude controller 312 may then modify the portion of the received signal in the additional antenna Rx 2 304 via the complex multiplier 308.

In operation, the RF phase and amplitude controller 312 may apply the signals e^{jw}^{ᵣ₁}^{t} and e^{jw}^{ᵣ₂}^{t} to the complex multipliers 306a and 306b based on control information provided by the phase rotator start controller 314. The RF phase and amplitude controller 312 may select the rotation waveform source based on the control information provided by the phase rotator start controller 314. Once the channel weights are determined by the SWG algorithm block 320 and the phase and amplitude components have been transferred to the RF phase and amplitude controller 312, the algorithm end signal may be utilized to change the selection in the RF phase and amplitude controller 312. In this regard, the RF phase and amplitude controller 312 may be utilized to select and apply the signals A₁e^{jφ}^{₁} and A₂e^{jφ}^{₂} to the complex multipliers 308a and 308b in FIG. 3A. At least some of the various portions of the receiver system 300 in FIG. 3A may be implemented in the OFDM block 154 of the mobile terminal 150 in FIG. 1B to support spatial multiplexing with single weight diversity, for example.

FIG. 3B is a block diagram of an exemplary system for providing phase rotation, channel estimation and for determining optimal phase and amplitude parameters or setting for additional K-1 receive antennas, in accordance with an embodiment of the invention. Referring to FIG. 3B, a receiver system 340 may differ from the receiver system 300 in FIG. 3A in that (K-1) additional receive antennas may be utilized. The receiver system 340 may be substantially described as illustrated in FIG. 3C. In this regard, the SWG channel estimator 318 may be adapted to process the combined channel estimates, ĥ₁ . . . ĥ_{N}, and determine the propagation channel matrix estimate Ĥ_{KxN}.

Referring to the FIG. 3B, multiple receive antennas may be connected to each of the RF chains RF_{1 . . . K} as shown in FIG. 3B for the single RF chain RF₁. In this regard, the combined channel estimates ĥ₁ . . . ĥ_{N} and consequently the channel estimate matrix Ĥ_{KxN} may be determined per each RF chain RF₁ . . . RF_{K}. Consequently, following this example, N matrices Ĥ_{KxN} may form a channel estimate matrix Ĥ_{MxN} in FIG. 3B (M=NK).

The SWG algorithm block 320 may also be adapted to determine (K-1) channel weights per RF chain, that may be utilized to maximize receiver SINR, for example, to be applied to a plurality of mixers to modify the portions of the transmitted single channel communication signals received by additional receive antennas. The (K-1) channel weights per RF chain may comprise amplitude and phase components, A₁₁ to A_{K-1,K-1} and φ₁₁ to φ_{K-1,K-1}. The RF phase and amplitude controller 312 may also be adapted to apply rotation waveforms e^{jw}^{ᵣ₁}^{t} to e^{jw}^{_{r(K-1)}}^{t} or phase and amplitude components, A₁₁ to A_{K-1,K-1} and φ₁₁ to φ_{K-1,K-1}, to a plurality of mixers. In this regard, the RF phase and amplitude controller 312 may apply the rotation waveforms or the amplitude and phase components in accordance with the control signals provided by the phase rotator start controller 314 and/or the algorithm end signal generated by the SWG algorithm block 320.

FIG. 3C is a block diagram of an exemplary receiver system, in accordance with an embodiment of the invention. Referring to FIG. 3C, there is shown a receiver system 340 as illustrated in FIG. 3B. The receiver system 340 may comprise a plurality of receive antennas 354_{1 . . . K}, a plurality of mixers 356_{1 . . . K-1}, and a plurality of summers 358_{1 . . . K}. The plurality of mixers 356_{1 . . . K-1} may be adapted to modify the portions of the transmitted single channel communication signals received by the plurality of receive antennas 354_{1 . . . K}. The plurality of summers 358_{1 . . . K} may combine the received signals into a plurality of RF signals RF_{1 . . . K}, for example. The (K-1) channel weights per RF chain may comprise amplitude and phase components, A₁₁ to A_{K-1,K-1} and φ₁₁ to φ_{K-1,K-1}.

FIG. 4A is a block diagram of exemplary N Tx antenna and M Rx antenna spatially multiplexed wireless communication system with receiver channel estimation, in accordance with an embodiment of the invention. Referring to FIG. 4A, the wireless system 400 may comprise a plurality of RF transmit blocks 430_{1 . . . N}, a plurality of transmit antennas 428_{1 . . . N} on the transmit side. On the receive side, the wireless system 400 may comprise a plurality of receive antennas 406_{1 . . . M}, a single weight generator (SWG) 410, a plurality of RF blocks 414_{1 . . . P}, a plurality of filters 416_{1 . . . P}, a spatially multiplexed baseband (SMBB) processor 426 and a single weight generator baseband processor (SWGBB) 421. The SWGBB 421 may comprise a channel estimator 422 and a single weight generator (SWG) algorithm block 424.

The RF transmit blocks 430_{1 . . . N} may comprise suitable logic, circuitry, and/or code that may be adapted to process an RF signal. The RF transmit blocks 430_{1 . . . N} may perform, for example, filtering, amplification, and mixing operations. The plurality of transmit antennas 428_{1 . . . N} may transmit the processed RF signals from the plurality of RF transmit blocks 430_{1 . . . N} to a plurality of receive antennas 406_{1 . . . M}, where the number of transmit antennas N may be equal to the number of RF paths N. The plurality of receive antennas 406_{1 . . . M} may each receive at least a portion of the transmitted signal. The SWG 410 may comprise suitable logic, circuitry, and/or code that may be adapted to determine a plurality of weights to be applied to each of the input signals R_{1 . . . M}. The SWG 410 may be adapted to modify the phase and amplitude of a portion of the transmitted signals received by the plurality of receive antennas 406_{1 . . . M} and generate a plurality of output signals RF_{1 . . . P}.

The plurality of RF blocks 414_{1 . . . P} may comprise suitable logic, circuitry, and/or code that may be adapted to process an RF signal. The RF blocks 414_{1 . . . P} may perform, for example, filtering, amplification, and analog-to-digital (A/D) conversion operations. The plurality of transmit antennas 438 and 440 may transmit the processed RF signals to a plurality of receive antennas 406_{1 . . . M}. The single weight generator SWG 410 may comprise suitable logic, circuitry, and/or code that may be adapted to determine a plurality of weights, which may be applied to each of the input signals. The single weight generator SWG 410 may be adapted to modify the phase and amplitude of at least a portion of the signals received by the plurality of receive antennas 406_{1 . . . M} and generate a plurality of output signals RF_{1 . . . P}. The plurality of RF receive blocks 414_{1 . . .P} may comprise suitable logic, circuitry and/or code that may be adapted to amplify and convert the received analog RF signals RF_{1 . . . P} down to baseband. The plurality of RF receive blocks 414_{1 . . . P} may each comprise an analog-to-digital (A/D) converter that may be utilized to digitize the received analog baseband signal.

The plurality of filters 416_{1 . . . P} may comprise suitable logic, circuitry and/or code that may be adapted to filter the output of the plurality of RF receive blocks 414_{1 . . . P} so as to produce in-phase (I) and quadrature (Q) components (I, Q). The outputs of the plurality of filters 416_{1 . . . P} may be transferred to the SMBB processor 426.

The SMBB 426 may be adapted to receive a plurality of in-phase and quadrature components (I, Q) from a plurality of filters 416_{1 . . . P} and generate a plurality of baseband combined channel estimates ĥ₁ to ĥₚ. The SMBB 426 may be adapted to generate a plurality of estimates \hat{X}₁ to \hat{X}_{P} of the original input spatial multiplexing sub-stream signals or symbols X₁ to X_{P}. The SMBB 426 may be adapted to separate the different space-time channels utilizing a Bell Labs Layered Space-Time (BLAST) algorithm, for example, by performing sub-stream detection and sub-stream cancellation. The transmission capacity may be increased almost linearly by utilizing the BLAST algorithm.

The channel estimator 422 may comprise suitable logic, circuitry, and/or code that may be adapted to process the received estimates ĥ₁ to ĥₚ from the SMBB processor 426 and may generate a matrix Ĥ of processed estimated channels that may be utilized by the single weight generator (SWG) algorithm block 424.

The SWG algorithm block 424 may determine a plurality of amplitude and phase values A₁ and φ_{I}, respectively, which may be utilized by SWG 410 to modify the phase and amplitude of a portion of the transmitted signals received by the plurality of receive antennas 406_{1 . . . M} and generate a plurality of output signals RF_{1 . . . P}.

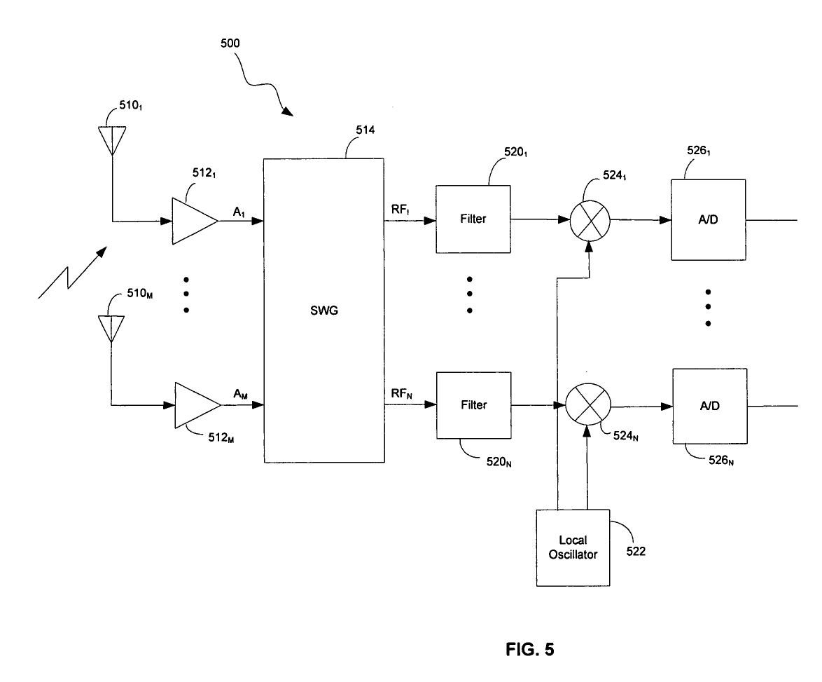

FIG. 4B is a flow diagram illustrating exemplary steps for determining channel weights in additional receive antennas utilizing signal-to-noise ratio (SNR) or signal-to-interference-and-noise ratio (SINR), in accordance with an embodiment of the invention. Referring to FIG. 4B, after start step 452, in step 454, the SWG algorithm block 320 may determine whether the signals received in the receive antennas are noise limited. The SWG algorithm block 320 may receive noise statistics and/or other noise information from either the CPP 418_{1 . . . P} (FIG. 5) and/or from the spatial multiplexing processor 426. When the received signals are noise limited, the flow diagram control may proceed to step 458. In step 458, the SWG algorithm block 320 may generate models for the received signals. For example, the models for a 1-Tx and 2-Rx antennas system may be represented by the following expressions:
r₁=h₁s+n₁,
r₂=Ae^{jθ}h₂s+Ae^{jθ}n₂, and
y=r₁+r₂=s(h₁+Ae^{jθ}+h₂)+n₁+Ae^{jθ}n₂.
where r₁ may represent a model of the signal received in a first receive antenna, r₂ may represent a model of the signal received in the second receive antenna, s may represent the transmitted signal, and n₁ may represent a noise component at the first receive antenna, whose time varying impulse response is represented by h₁. The parameter n₂ may represent a noise component at the second receive antenna, whose time varying impulse response is represented by h₂, θ may represent the phase factor between the signal received in the first and second receive antennas, and A may represent an amplitude factor. The parameter y may represent the sum of the received signal models and may comprise a combined signal component s(h₁+Ae^{jθ}h₂) and a combined noise component n₁+Ae^{jθ}n₂.

For the case of a MIMO system with N-transmit and M-receive antennas, the models may be represented by the expressions:

$$\begin{matrix}{r}_{k} = {\sum }_{i = 1}^{N} ( {A}_{k} {ⅇ}^{jϑ} k {h}_{i k} s + {A}_{k} {ⅇ}^{jϑ} k {n}_{ k} ) , \\ y = {\sum }_{k = 1}^{M} ( {r}_{k} ) ,\end{matrix}$$

where rₖ may represent the model of the signal received from the N transmit antennas by the k^{th} receive antenna, hᵢₖ may represent the time varying impulse response of the propagation channel between the i^{th} transmit antenna and the k^{th} receive antenna, and s may represent the transmitted signal, nₖ may represent a noise component at the k^{th} receive antenna The parameter Aₖ may correspond to the amplitude factor associated with the k^{th} receive antenna, θₖ may correspond to the phase factor associated with the k^{th} receive antenna, and y may represent the sum of the M received signal models. In this regard, Aₖ(k=1)=1 and θₖ(k=1)=0.

In step 460, the received signal models may be utilized to determine a signal strength parameter. In this regard, the signal-to-noise ratio (SNR) may correspond to the signal strength parameter to be determined. For example, for a 1-Tx and 2-Rx antennas system, the SNR may be determined by maximizing the following expression for various phase, θ, and amplitude, A, factors:

$$SNR = \frac{{‖ {h}_{1} + A {ⅇ}^{jϑ} {h}_{2} ‖}^{2}}{E {‖ {n}_{1} ‖}^{2} + E {‖ A {ⅇ}^{jϑ} {n}_{2} ‖}^{2}} = \frac{{‖ {h}_{1} + A {ⅇ}^{jϑ} {h}_{2} ‖}^{2}}{{σ}^{2} ( 1 + {A}^{2} )} .$$

The SNR numerator may correspond to the y parameter's combined signal component while the SNR denominator may correspond to the y parameter's combined noise component. The phase factor, θ, may be selected, for example, from a 360-degrees phase rotation while the amplitude factor, A, may be selected, for example, from an set amplitude range. In one embodiment of the invention, the phase factor may be varied in a plurality of phase factor steps over the 360-degrees phase rotation to find the maximum SNR value. In another embodiment of the invention, the phase factor may be varied in a plurality of phase factors steps over the 360-degrees phase rotation and the amplitude factor may be varied in a plurality of amplitude factor values over the amplitude range to find the maximum SNR value.

In step 470, after determining the maximum SNR in step 460, the SWG algorithm block 320 may utilize the amplitude factor and phase factor that corresponds to the maximum SNR to determine the amplitude and phase to be provided to the RF amplitude and phase controller 312 in step 470. For example, in one embodiment of the invention, the amplitude and/or phase factors that correspond to the maximum SNR may be utilized as the amplitude and phase to be transferred to the RF amplitude and phase controller 312. After application of the appropriate amplitude and phase by the RF amplitude and phase controller 312 to the receive antennas, the flow diagram control may proceed to end step 472 until a next phase and amplitude determination is necessary.

Returning to step 454, when received signals are not noise limited, the flow control may proceed to step 456 where a determination may be made as to whether multiple interfering signals may be present and may need to be considered during channel weight determination. When a single interferer is considered, the flow diagram control may proceed to step 462. In step 462 the SWG algorithm block 320 may generate models for the received signals. For example, the models for a 1-Tx and 2-Rx antennas system may be represented by the following expressions:
r₁=h₁s+h_{I1}s_{I}+n₁,
r₂=Ae^{jθ}(h₂s+h_{I2}s_{I}+n₂), and
y=r₁+r₂=s(h₁+Ae^{jθ}h₂)+n₁+s_{I}(h_{I1}+Ae^{jθ}h_{I2})+Ae^{jθ}n₂,
where r₁ may represent a model of the signal received in a first receive antenna, r₂ may represent a model of the signal received in the second receive antenna, s may represent the transmitted signal, s_{I} may represent the interference signal, and n₁ may represent a noise component at the first receive antenna whose time varying impulse response is h₁. The parameter n₂ may represent a noise component at the second receive antenna whose time varying impulse response is h₂, θ may represent the phase factor between the signal received in the first and second receive antennas, and A may represent an amplitude factor. Moreover, the time varying impulse response h_{I1} may correspond to the propagation channel between the interference signal source and the first receive antenna and the time varying impulse response h_{I2} may correspond to the propagation channel between the interference signal source and the second receive antenna. The parameter y may represent the sum of the received signal models and may comprise a combined signal component s(h₁+Ae^{jθ}h₂) and a combined noise plus interference component n₁+s_{I}(h_{I1}+Ae^{jθ}h_{I2})+Ae^{jθ}n₂.

For the case of a MIMO system with N-transmit and M-receive antennas, the models may be represented by the expressions:

$$\begin{matrix}{r}_{k} = {\sum }_{i = 1}^{N} ( {A}_{k} {ⅇ}^{jϑ} k {h}_{i k} s + {A}_{k} {ⅇ}^{jϑ} k {h}_{l k} {s}_{l} + {A}_{k} {ⅇ}^{jϑ} k {n}_{k} ) , \\ y = {\sum }_{k = 1}^{M} ( {r}_{k} ) ,\end{matrix}$$

where rₖ may represent the model of the signal received from the N transmit antennas by the k^{th} receive antenna, hᵢₖ may represent the propagation channel between the i^{th} transmit antenna and the k^{th} receive antenna, s may represent the transmitted signal, s_{I} may represent the interference signal, nₖ may represent a noise component at the k^{th} receive antenna, h_{Ik} may represent the time varying impulse response of propagation channel between the interference source and the k^{th} receive antenna. The parameter Aₖ may correspond to the amplitude factor associated with the k^{th} receive antenna, θₖ may correspond to the phase factor associated with the k^{th} receive antenna, and y may represent the sum of the M received signal models. In this regard, Aₖ(k=1)=1 and θₖ (k=1)=0.

In step 464, the received signal models may be utilized to determine a signal strength parameter. In this regard, the signal-to-interference-and-noise ratio (SINR) may correspond to the signal strength parameter to be determined. For example, for a 1-Tx and 2-Rx antennas system, the SINR may be determined by maximizing the following expression for various phase, θ, and amplitude, A, factors:

$$SINR = \frac{{‖ {h}_{1} + A {ⅇ}^{jϑ} {h}_{2} ‖}^{2}}{E {‖ {n}_{1} ‖}^{2} + E {‖ A {ⅇ}^{jϑ} {n}_{2} ‖}^{2} + {‖ {h}_{l 1} + A {ⅇ}^{jϑ} {h}_{l 2} ‖}^{2}} = \frac{{‖ {h}_{1} + A {ⅇ}^{jϑ} {h}_{2} ‖}^{2}}{{σ}^{2} ( 1 + {A}^{2} ) + {‖ {h}_{l 1} + A {ⅇ}^{jϑ} {h}_{l 2} ‖}^{2}} .$$

where σ² is the noise power. The above SINR equations may be easily extended, by one skilled in art, to the single channel MIMO case.

The SINR numerator may correspond to the y parameter's combined signal component while the SINR denominator may correspond to the y parameter's combined noise plus interference component. The phase factor, θ, may be selected, for example, from a 360-degrees phase rotation while the amplitude factor, A, may be selected, for example, from an set amplitude range. In one embodiment of the invention, the phase factor may be varied in a plurality of phase factor steps over the 360-degrees phase rotation to find the maximum SNR value. In another embodiment of the invention, the phase factor may be varied in a plurality of phase factors steps over the 360-degrees phase rotation and the amplitude factor may be varied in a plurality of amplitude factor values over a range of amplitudes to find the maximum SINR value.

After determining the SINR in step 464, the SWG algorithm block 320 may determine the amplitude and phase to be provided to the RF amplitude and phase controller 312 in step 470. After application of the appropriate amplitude and phase by the RF amplitude and phase controller 312, the flow diagram control may proceed to end step 472 until a next phase and amplitude determination is necessary.

Returning to step 456, when multiple taps or multiple paths in the channel impulse response may need to be considered, the flow diagram control may proceed to step 466. In step 466, the SWG algorithm block 320 may generate the received signal models for cases in which multiple taps or interference sources are considered. In step 468, the SWG algorithm block 320 may utilize the received signal models to determine the SINR for multiple interferers. When the desired signal has i=1, . . . , P taps or multiple paths with different delays and the interfering signal has k−1, . . . , R taps or multiple paths with different delays, then the maximum SINR solution for the 1-Tx and 2-Rx antenna system in that case may be as follows:

$${SINR}_{max} = \frac{{\sum }_{i = 1}^{P} {‖ {h}_{1 } + A {ⅇ}^{jϑ} {h}_{2} ‖}^{2}}{{σ}^{2} ( 1 + {A}^{2} ) + {\sum }_{k = 1}^{R} {‖ {h}_{l 1} + A {ⅇ}^{jϑ} {h}_{l 2} ‖}^{2}} .$$

After determining the SINR in step 468, the SWG algorithm block 320 may determine the amplitude and phase to be provided to the RF amplitude and phase controller 312 in step 470. After application of the appropriate amplitude and phase by the RF amplitude and phase controller 312, the flow diagram control may proceed to end step 472 until a next phase and amplitude determination is necessary.

The operations to maximize the signal strength described for steps 460, 464, and 468 may be based on a search algorithm. In an exemplary embodiment of the invention, a search algorithm may be utilized to search over 360-degrees phase rotation in 45-degree or 90-degree phase factor steps and over a 0-5 amplitude range in 0.25 amplitude values or steps, for example. For a 1-Tx and 2-Rx antenna system, with 90-degree phase factor steps, a phase only search algorithm may calculate 4 SNR or SINR values, for example. For a 2-Tx and 2-Rx antenna system with STTD transmit mode, with 90-degree phase factor steps, a phase only search algorithm may calculate 4 SNR or SINR values.

In another embodiment of the invention, a closed-form mathematical expression may also be utilized to maximize the SNR and/or the SINR. Utilizing an algorithm or closed-form expression that maximizes the SINR or SNR may provide a good compromise between implementation complexity and performance gains. Notwithstanding, the invention is not limited in this regard, and other channel weight algorithms may also be utilized.

FIG. 5 is a block diagram of an exemplary receiver illustrating spatial multiplexing in a MIMO communication system that may be utilized in connection with an embodiment of the invention. Referring to FIG. 5, there is shown a receiver 500 that comprises a plurality of receive antennas 510_{1,2, . . . ,M}, a plurality of amplifiers 512_{1,2, . . . ,M}, a SWG block 514, a plurality of filters 520_{1,2, . . . ,N}, a local oscillator 522, a plurality of mixers 524_{1,2, . . . ,N}, a plurality of analog to digital (A/D) converters 526_{1,2, . . . ,N} and a spatial multiplexing baseband processor SMBB 530.

The antennas 510_{1,2, . . . ,M} may be adapted to receive the transmitted signals. The amplifiers 512_{1,2, . . . . ,M} may be adapted to amplify the M received input signals. The SWG block 514 may comprise a plurality of amplitude and phase shifters to compensate for the phase difference between various received input signals. Weights may be applied to each of the input signals A_{1 . . . M} to modify the phase and amplitude of a portion of the transmitted signals received by the plurality of receive antennas 512_{1 . . . M} and generate a plurality of output signals RF_{1 . . . N}. The plurality of filters 520_{1,2, . . . ,N} may be adapted to filter frequency components of the RF substreams. The mixers 524_{1,2, . . . . ,N} may be adapted to downconvert the analog RF substreams to baseband. The local oscillator 522 may be adapted to provide a signal to the mixers 524_{1,2, . . . ,N}, which is utilized to downconvert the analog RF substreams to baseband. The analog to digital (A/D) converters 526_{1,2, . . . ,N} may be adapted to convert the analog baseband substreams into their corresponding digital substreams. The spatial multiplexing baseband processor SMBB 530 may be adapted to process the digital baseband substreams and multiplex the plurality of digital signals to generate output signals or symbols \hat{X}₁ . . . \hat{X}_{N} which may be estimates of the original spatial multiplexing sub-stream signals or symbols X₁ . . . X_{N}.

In operation, the MT RF signals transmitted by a plurality of transmitters may be received by a plurality of M receive antennas 510_{1,2, . . . ,M} deployed at the receiver 500. Each of the M received signals may be amplified by a respective low noise amplifier 512_{1,2, . . . M}. A plurality of weights may be applied to each of the input signals A_{1 . . . M} to modify the phase and amplitude of a portion of the transmitted signals received by the plurality of receive antennas 512_{1 . . . M}. A plurality of output signals RF_{1 . . . N} may be generated, which may be filtered by a plurality of filters 520_{1,2, . . . ,N}. The resulting N filtered signals may then be downconverted to baseband utilizing a plurality of N mixers 524_{1,2, . . . ,N}, each of which may be provided with a carrier signal that may be generated by a local oscillator 522. The N baseband signals generated by the mixers 524_{1,2, . . . ,N} may then be converted to digital signals by a plurality of analog to digital (A/D) converters 526_{1,2, . . . ,N}. The N digital signals may further be processed by a spatial multiplexing baseband processor SMBB 530 to generate an output signals \hat{X}₁ . . . \hat{X}_{N}, which are estimates of the original spatial multiplexing sub-stream signals or symbols X₁ . . . X_{N}.

Another embodiment of the invention may provide a machine-readable storage, having stored thereon, a computer program having at least one code section executable by a machine, thereby causing the machine to perform the steps as described above for increasing capacity of DVB-H downlink communication channel.

In an embodiment of the invention, a system for processing signals in a communication system may comprise a plurality of receive antennas, for example, plurality of receive antennas 406_{1 . . . M} (FIG. 4A) that receive a plurality of spatially multiplexed communication signals for a plurality of channels via a digital video broadcast (DVB) communication path. At least one processor, for example, the SWGBB processor 421 (FIG. 4A) may be adapted to apply a plurality of channel weights to at least a portion of the plurality of spatially multiplexed communication signals. The plurality of receive antennas 406_{1 . . . M} may be adapted to receive high definition television (HDTV) broadcast information via the DVB communication path. A demodulator, for example, the DVB-H/HDTV demodulator 166 (FIG. 1D) may be adapted to demodulate the received HDTV broadcast information. The plurality of receive antennas 406_{1 . . . M} may be adapted to receive the HDTV broadcast information via a digital video broadcast handheld (DVB-H) communication path.

The SWGBB processor 421 may be adapted to adjust a phase and an amplitude of at least a portion of the received plurality of spatially multiplexed communication signals based on the applied plurality of channel weights. The applied plurality of channel weights may comprise at least one of: amplitude correction weights and phase correction weights. The SMBB processor 418 may be adapted to spatially demultiplex the received plurality of spatially multiplexed communication signals. The plurality of receive antennas 406_{1 . . . M} may be adapted to receive the plurality of spatially multiplexed communication signals for the plurality of channels via a digital video broadcast handheld (DVB-H) communication path. The SWGBB processor 421 may be adapted to combine the plurality of spatially multiplexed communication signals to generate a single combined receive signal. The processor 206 may be adapted to determine a plurality of channel estimates based on the combined plurality of spatially multiplexed communication signals.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing signals in a communication system, the method comprising:
receiving a plurality of spatially multiplexed communication signals for a plurality of channels via a digital video broadcast (DVB) communication path; and
applying a plurality of channel weights to at least a portion of said plurality of spatially multiplexed communication signals.

2. The method according to claim 1, further comprising receiving high definition television (HDTV) broadcast information via said DVB communication path.

3. The method according to claim 2, further comprising demodulating said received HDTV broadcast information.

4. The method according to claim 2, further comprising receiving said HDTV broadcast information via a digital video broadcast handheld (DVB-H) communication path.

5. The method according to claim 1, further comprising adjusting a phase and an amplitude of at least a portion of said received plurality of spatially multiplexed communication signals based on said applied plurality of channel weights.

6. The method according to claim 1, wherein said applied plurality of channel weights comprise at least one of: amplitude correction weights and phase correction weights.

7. The method according to claim 1, further comprising spatially demultiplexing said received plurality of spatially multiplexed communication signals.

8. The method according to claim 1, further comprising receiving said plurality of spatially multiplexed communication signals for said plurality of channels via a digital video broadcast handheld (DVB-H) communication path.

9. The method according to claim 1, further comprising combining said plurality of spatially multiplexed communication signals to generate a single combined receive signal.

10. The method according to claim 9, further comprising determining a plurality of channel estimates based on said combined plurality of spatially multiplexed communication signals.

11. A machine-readable storage having stored thereon, a computer program having at least one code section for processing signals in a communication system, the at least one code section being executable by a machine for causing the machine to perform steps comprising:
receiving a plurality of spatially multiplexed communication signals for a plurality of channels via a digital video broadcast (DVB) communication path; and
applying a plurality of channel weights to at least a portion of said plurality of spatially multiplexed communication signals.

12. The machine-readable storage according to claim 11, further comprising code for receiving high definition television (HDTV) broadcast information via said DVB communication path.

13. The machine-readable storage according to claim 12, further comprising code for demodulating said received HDTV broadcast information.

14. The machine-readable storage according to claim 12, further comprising code for receiving said HDTV broadcast information via a digital video broadcast handheld (DVB-H) communication path.

15. The machine-readable storage according to claim 11, further comprising code for adjusting a phase and an amplitude of at least a portion of said received plurality of spatially multiplexed communication signals based on said applied plurality of channel weights.

16. The machine-readable storage according to claim 11, wherein said applied plurality of channel weights comprise at least one of: amplitude correction weights and phase correction weights.

17. The machine-readable storage according to claim 11, further comprising code for spatially demultiplexing said received plurality of spatially multiplexed communication signals.

18. The machine-readable storage according to claim 11, further comprising code for receiving said plurality of spatially multiplexed communication signals for said plurality of channels via a digital video broadcast handheld (DVB-H) communication path.

19. The machine-readable storage according to claim 11, further comprising code for combining said plurality of spatially multiplexed communication signals to generate a single combined receive signal.

20. The machine-readable storage according to claim 19, further comprising code for determining a plurality of channel estimates based on said combined plurality of spatially multiplexed communication signals.

21. A system for processing signals in a communication system, the system comprising:
a plurality of receive antennas that receive a plurality of spatially multiplexed communication signals for a plurality of channels via a digital video broadcast (DVB) communication path; and
circuitry that applies a plurality of channel weights to at least a portion of said plurality of spatially multiplexed communication signals.

22. The system according to claim 21, wherein plurality of receive antennas receive high definition television (HDTV) broadcast information via said DVB communication path.

23. The system according to claim 22, further comprising a demodulator that demodulates said received HDTV broadcast information.

24. The system according to claim 22, wherein said plurality of receive antennas receive said HDTV broadcast information via a digital video broadcast handheld (DVB-H) communication path.

25. The system according to claim 21, further comprising circuitry that adjusts a phase and an amplitude of at least a portion of said received plurality of spatially multiplexed communication signals based on said applied plurality of channel weights.

26. The system according to claim 21, wherein said applied plurality of channel weights comprise at least one of: amplitude correction weights and phase correction weights.

27. The system according to claim 21, further comprising circuitry that spatially demultiplexes said received plurality of spatially multiplexed communication signals.

28. The system according to claim 21, wherein said plurality of receive antennas receive said plurality of spatially multiplexed communication signals for said plurality of channels via a digital video broadcast handheld (DVB-H) communication path.

29. The system according to claim 21, further comprising circuitry that combines said plurality of spatially multiplexed communication signals to generate a single combined receive signal.

30. The system according to claim 29, further comprising circuitry that determines a plurality of channel estimates based on said combined plurality of spatially multiplexed communication signals.
